(19) United States
(12) Patent Application Publication
(10) Pub. No.: US 2020/0222157 A1
(43) Pub. Date: Jul. 16, 2020

(54) DENTAL PROSTHESES

(71) Applicant: Vita Zahnfabrik H. Rauter GmbH, Bad Saeckingen (DE)

(72) Inventors: Urban Christen, Bad Saeckingen (DE); Eva Kerschensteiner, Bad Saeckingen (DE)

(73) Assignee: Vita Zahnfabrik H. Rauter GmbH, Bad Saekingen (DE)

(21) Appl. No.: 16/830,321

(22) Filed: Mar. 26, 2020

Related U.S. Application Data
(62) Division of application No. 14/890,800, filed on Nov. 12, 2015.

(30) Foreign Application Priority Data
May 13, 2013 (EP) 13167514.2

(51) Int. Cl. A61C 13/08; A61C 13/10; A61C 13/01

(52) U.S. Cl. CPC A61C 13/082; A61C 13/01; A61C 13/102

(57) ABSTRACT

A blank for producing dental prostheses by particularly material-removing processing comprises a tooth element and a jaw element. These elements are preferably differently colored layers of a blank produced from the same material. In order to cover a dividing line between the differently colored regions, a gum element is arranged especially in a recess of the finished dental prosthesis.

### CROSS REFERENCE TO RELATED APPLICATIONS

This application is a division of U.S. application Ser. No. 14/890,800 filed Nov. 12, 2015 (the '800 Application), the entire contents of which are incorporated herein by reference. The '800 Application is a national stage of International Application PCT/EP2014/059390 filed May 7, 2014, which claims the benefit of European Application EP13167514.2 filed May 13, 2013.

### BACKGROUND

### 1. Field of the Disclosure

The disclosure relates to dental prostheses, which may be partial prostheses or full prostheses.

### 2. Discussion of the Related Art

For the production of dental prostheses, it is known from DE 20 2012 100 359 to build up a blank, which in particular is a circular cylindrical round blank, from a plurality of layers. The individual layers are colored or pigmented differently. A dental prosthesis is formed from the blank by a material-removing processing, in particular by milling and grinding. The multi-layered structure of the blank serves, on the one hand, to form a tooth element and, on the other hand, to form a jaw element. The material layer that forms the tooth element is colored in the color of a tooth. The at least one tooth is milled from this portion of the blank. The layer of the blank that forms the tooth element is adjoined by a layer that is in particular gingiva-colored, which layer forms the jaw element. From this region of the blank the part of the dental prosthesis is formed that adjoins the teeth and essentially imitates the gingiva. In the finished state the jaw element rests on the jaw and, in the case of a maxillary prosthesis, also contacts the palate. It is a drawback of multi-layered round blanks that substantially straight, clearly discernible dividing lines exist between the individual layers. This is disadvantageous in particular with the layers of strongly differing colors that, on the one hand, form the tooth element and, on the other hand, form the jaw element. As a result, no aesthetic natural impression is achieved. This is inacceptable to patients especially in the region of the teeth that are visible when the mouth is open.

It is an object of the disclosure to provide dental prostheses having an appearance that is close to natural aesthetics.

### SUMMARY

A blank for producing dental prostheses is used to produce partial prostheses and/or full prostheses. The production of a prosthesis is performed in particular by a material-removing processing such as milling. The blank has at least two layers which, however, are a tooth element and a jaw element. The tooth element serves to imitate at least one tooth by material-removing processing, with the portion of the blank forming the partial element being colored or pigmented preferably in the color of a tooth. The jaw element serves to form the element of the dental prosthesis adjoining the tooth element and being in contact with the jaw and a maxillary splint, as well as with the palate. It is particularly preferred that the blank is formed as a single piece, wherein in particular substantially the same material is used for the tooth element and the jaw element, and the same is colored or pigmented correspondingly, so that the tooth element is preferably tooth-colored and the jaw element is preferably gingiva-colored.

In order to conceal or cover the dividing line occurring between the tooth element and the jaw element, the disclosure provides a gingiva element. The gingiva element is arranged in a receiving portion of the tooth element and/or the jaw element so as to produce the dental prosthesis of the present disclosure.

In this regard, the gingiva element is preferably tooth-colored and is fixed, e.g. by adhesive bonding, to the tooth element and/or the jaw element after the material-removing processing. By providing one or a plurality of such gingiva elements, it is possible to cover a dividing line between the tooth element and the jaw element in particular in the visible part of the dental prosthesis, i.e. the part between the tooth element and the jaw element that is visible in an open mouth. This is also advantageous if no distinct dividing line exists between the two elements, since it is possible, according to a preferred development, to form the gingiva element such that it also extends into regions between adjacent teeth. For this purpose, it is preferred that the at least one gingiva element has wedge-shaped or pointed protrusions, for example, which would be arranged between two adjacent teeth. Preferably, these protrusions have side edges extending towards each other. It is possible to thereby achieve a very natural impression of the dental prosthesis.

A preferred embodiment of the gingiva element having at least one, in particular a plurality, of protrusions arranged between adjacent teeth is preferably designed such that the protrusions are connected with each other by means of a connecting element.

This is advantageous in that a plate-shaped, in particular bent gingiva element can be formed that, on the one hand, covers the dividing line between the tooth element and the jaw element and, on the other hand, a single element can be used to fill the spaces between a plurality of adjacent teeth and to realize a natural appearance of the dental prosthesis.

In order to avoid disturbing edges or transitions even with very thin gingiva elements, it is preferred in a particularly preferred development to design the receiving portion for the at least one gingiva element as a recess or a plurality of recesses into which the corresponding gingiva element is placed. This has the advantage that a substantially smooth transition is obtained.

The blank for dental prostheses is made from a polymer material, for example.

The blank may have a first and a second layer, with the first layer differing in color from the second layer which is in contact with the first layer and the first layer being preferably gingiva-colored, while the second layer is preferably tooth-colored. The first and second layers are preferably made from similar or different basic plastic material, with the second layer having a greater surface hardness than the first layer.

The plastic material of the first and/or the second layer is preferably polymethyl methacrylate (PMMA), polyamide, polycarbonate or combinations thereof.

In another embodiment, the blank of the present disclosure is characterized in that a filler is present in the second layer to provide the basic plastic material with a higher surface hardness and/or abrasion resistance as compared to the first layer. The filler may be, for example, a silanized filler, silanized silicon dioxide or quartz powder.

In a further embodiment, the blank of the present disclosure is characterized in that the abrasion resistance of the second layer is higher as compared to the first layer.

The blank of the present disclosure can be produced by means of a method which is characterized by providing, for producing the first layer of the blank of the present disclosure, a first mixture of gingiva-colored plastic particles with the corresponding plastic monomers and, possibly, a radical chain starter; providing, for producing the second layer of the blank of the present disclosure, a second mixture of the filler with gingiva-colored plastic particles, the corresponding plastic monomers and, possibly, a radical chain starter; arranging the first and the second mixture one above the other in a mold and polymerizing the same; and thereafter, removing the blank from the mold.

The following is a detailed explanation of the disclosure with reference to a preferred embodiment and to the accompanying drawings.

### BRIEF DESCRIPTION OF THE DRAWINGS

In the Figures:

FIG. 1 is a schematic perspective illustration of a circular cylindrical round blank for producing a dental prosthesis;

FIG. 2 is a front view of a dental prosthesis produced from the circular cylindrical round blank;

FIG. 3 is a side elevational view of a dental prosthesis produced from the circular cylindrical round blank; and

FIG. 4 is a schematical top plan view of a gingiva element.

### DETAILED DESCRIPTION

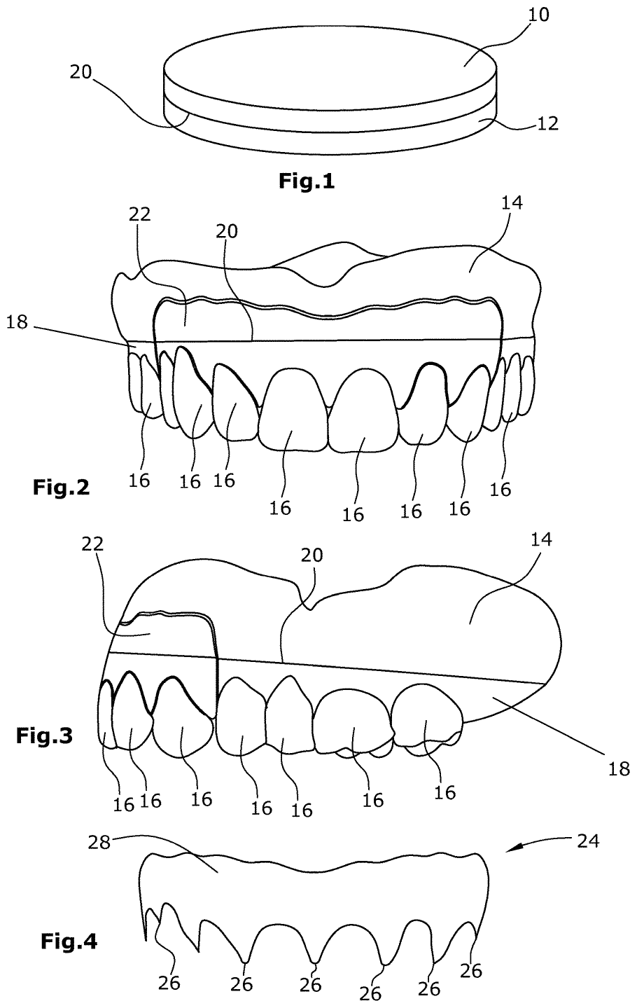

A full prosthesis may be produced from a round blank which, in the embodiment illustrated, is a two-layered, circular cylindrical blank. In the embodiment illustrated, the round blank comprises two layers 10, 12 which are in particular made from the same material, but are colored differently. An upper layer 10 in FIG. 1 serves to form the jaw element and is preferably gingiva-colored. This layer is adjoined by a lower layer 12 in FIG. 1 which serves to form the tooth element that, in a full prosthesis, imitates the entirety of the teeth.

The jaw element 14 and the tooth element 18 (FIG. 2), which forms the individual teeth 16, are formed for the individual patient by material-removing processing such as milling, grinding and the like. Due to the different coloring of the tooth element 18 and the jaw element 14, a possibly distinct dividing line 20 is obtained between these two elements. This creates an unnatural appearance especially in the region of the visible teeth.

Therefore, according to the disclosure, a receiving portion 22 in the form of a recess is provided. The same is preferably also made by material-removing processing. The recess 22 extends along the visible teeth e.g. up to the molars as schematically shown in FIG. 3.

In order to cover the dividing line 20 between the tooth element 18 and the jaw element 14, a gingiva element 24 (FIG. 4) is inserted into the recess 22 and is fixed therein in particular by adhesive bonding.

In the particularly preferred embodiment illustrated, the gingiva element is formed such that it has a plurality of protrusions 26 which, in the mounted state of the gingiva element 24, are arranged between adjacent teeth 16 and thus imitate the natural course of the gingiva. The individual protrusions 26 are connected by means of a connecting element 28, with the entire gingiva element 24 being preferably produced as a single piece.

The production of the gingiva element 24 is preferably also performed by material-removing processing such as milling, grinding and the like. It is possible to produce the gingiva element, which has the color of the layer 10, from a region of the round blank that would be removed during the production of the dental prosthesis. In this regard, it is not necessary to provide another blank for the production of the gingiva element.

What is claimed is:

1. A method of producing dental prostheses, comprising:
producing a gingiva-colored layer from a first mixture of gingiva-colored plastic particles with plastic monomers;
producing a tooth-colored layer from a second mixture of a tooth-colored plastic particles with plastic monomers;
arranging the first and second mixtures one above the other in a mold;
polymerizing the first and second mixtures to form a single piece blank having a dividing line between the gingiva-colored layer and the tooth-colored layer; and
removing the single piece blank from the mold.

2. The method of claim 1, wherein the dividing line is a substantially straight, clearly discernible dividing line.

3. The method of claim 1, wherein the first and/or second mixtures comprises a radical chain starter.

4. The method of claim 1, wherein the single piece blank is circular.

5. The method of claim 1, wherein the single piece blank is sized and configured to produce a partial dental prostheses.

6. The method of claim 1, wherein the single piece blank is sized and configured to produce a full dental prostheses.

7. The method of claim 1, wherein the tooth-colored layer has a greater surface hardness than the gingiva-colored layer.

8. The method of claim 1, wherein the tooth-colored layer has a greater abrasion resistance than the gingiva-colored layer.

9. The method of claim 1, wherein the plastic monomer of the first and/or the second mixtures is/are selected from a group consisting of polymethyl methacrylate (PMMA), polyamide, polycarbonate, and any combinations thereof.

10. The method of claim 1, wherein the second mixture further comprises filler selected from a group consisting of a silanized filler, a silanized silicon dioxide, and a quartz powder.

11. The method of claim 1, further comprising:
removing material from the gingiva-colored layer to define a jaw element; and
removing material from the tooth-colored layer a tooth element having at least two teeth.

12. The method of claim 11, further comprising covering the dividing line between the tooth-colored layer and the gingiva-colored layer with a gingiva element.

13. The method of claim 12, wherein the gingiva element is gingiva-colored.

14. The method of claim 12, further comprising forming the gingiva element from a region of the gingiva-colored layer removed from the single piece blank.

15. The method of claim 12, further comprising:
removing material from the gingiva-colored and/or tooth-colored layers to define a receiving portion; and
covering the dividing line between the tooth-colored layer and the gingiva-colored layer by fixing the gingiva element to the receiving portion.

16. The method of claim 15, wherein the covering step comprises adhesive bonding of the gingiva element to the receiving portion.

17. The method of claim 15, wherein the gingiva element has a wedge-shaped or pointed protrusion shaped and configured, the gingiva element being fixed to the receiving portion with the wedge-shaped or pointed protrusion arranged between the at least two teeth.

18. The method of claim 17, wherein the receiving portion is a recess into which the gingiva element is received to provide a substantially smooth transition between the receiving portion and the gingiva-colored and/or tooth-colored layers.

19. The method of claim 15, wherein the receiving portion is a recess into which the gingiva element is received to provide a substantially smooth transition between the receiving portion and the gingiva-colored and/or tooth-colored layers.

20. The method of claim 1, further comprising producing another layer in addition to the tooth-colored layer and the gingiva-colored layer.
